(19) United States
(12) Patent Application Publication
(10) Pub. No.: US 2010/0157054 A1
(43) Pub. Date: Jun. 24, 2010

(54) MULTI-REGION MONITORING SYSTEM

(75) Inventors: HAI-CHOU TIEN, Tucheng City (TW); CHIN-LUN LAI, Banciao City (TW)

Correspondence Address: KILE GOEKJIAN REED & MCMANUS, 1200 NEW HAMPSHIRE AVE, NW, SUITE 570, WASHINGTON, DC, 20036, US

(73) Assignees: LI-SHIH LIAO; CHIN-DING LAI; HAI-CHOU TIEN

(21) Appl. No.: 12/644,837

(22) Filed: Dec. 22, 2009

(30) Foreign Application Priority Data
Dec. 24, 2008 (TW) 097150400

(51) Int. Cl. H04N 7/18

(52) U.S. Cl. 348/143; 348/E07.085

(57) ABSTRACT

A multi-region monitoring system comprises: an image-capturing module having a lens assembly; and a mirror assembly having at least two mirrors, wherein the mirrors face the lens assembly. By adjusting the rotation angle of the mirrors, objects of several specific regions can be reflected in the mirrors, and the image-capturing module captures a digital image of the mirrors and the objects reflected therein. Due to the capturing range of the image-capturing module including the mirrors only, the captured digital image is able to have high resolution.

### CROSS-REFERENCE TO RELATED APPLICATION

This application claims priority under 35 U.S.C. §119 to Taiwan Patent Application No. 097150400, filed on Dec. 24, 2008, in the Taiwan Intellectual Property Office, the entire contents of which are hereby incorporated by reference.

### BACKGROUND OF THE INVENTION

1. Field of the Invention

The present invention relates to a multi-region monitoring system, in particular, to a multi-region monitoring system having a plurality of mirrors.

2. Description of Related Art

In recent years, home safety issues are receiving more attention by people, so more and more houses, streets, and public locations are provided with one or more cameras to monitor normalcy or whether abnormal situations are occurring therein, by which possible damage or injuries can be prevented in advance. For example, when the camera is provided with a view to the entry and a visitor then approaches the door, an image of the visitor's facial features and other identifying aspects will be captured by the camera, and the visitor's identity will be recognizable from the image, thereby preventing entry by unknown or visitors from entering the door.

For increasing the capturing or monitoring range, of the cameras, and reducing dead spots on monitoring, some cameras use a wide angle lens. The wide angle lens helps in increasing the capturing range of the camera, however also causes some deficiencies. For example, because capturing range is larger, resolution of the captured image is reduced, which means the details of the image are not necessarily clear, and edge sections of the image are deformed or distorted. Those deficiencies will make the image difficult to analyze and identify.

To overcome the deficiencies, some alternative solutions are proposed. For example, someone uses two cameras to construct a monitoring system, one camera is a wide-angle lens camera, and another one is a high resolution camera. The wide-angle lens captures images with larger range, and the high resolution camera captures images with smaller range, with high resolution, and the high resolution camera is capable of moving for changing where to capture images.

When using such the monitoring systems, the wide-angle camera first determines which local region within the capturing range has an occurrence of abnormality, the high resolution camera then moves to focus on that local region to capture at least one high resolution image of that local region. In this manner, the image of that local region can be easily analyzed and identified.

Though the abovementioned system can reduce issues resulting from low resolution images captured only by the wide-angle lens, the system still has other deficiencies. For example, the high resolution camera of the system can not capture images of two or more than two local regions at the same time. If there is a need to monitor several local regions at the same time, the system needs to add more high resolution cameras, and add more hardware to move the high resolution cameras, which increases the overall cost of the system, and reduces the willingness to buy.

Consequently, because of the above limitation resulting from the technical design of prior art, the inventor strives via real world experience, experimentation, and academic research to develop the present invention, which can effectively minimize the limitations described above.

### SUMMARY OF THE INVENTION

In view of the aforementioned issues, the present invention provides a multi-region monitoring system, the system uses only one capturing module to capture images in each of different plural regions, but the images of these regions are of high resolution.

To achieve the above-mentioned objectives, the present invention provides a multi-region monitoring system, which comprises: an image-capturing module having a lens assembly; and a mirror assembly, having at least two mirrors, the mirror assembly facing the lens assembly. Each of the mirrors reflects an object, and the lens assembly captures a digital image of the objects reflected in the mirrors.

The multi-region monitoring system of the present invention provides, at least, efficacies as follow:
1. The mirrors can reflect current circumstances and viewable objects of different regions, and the image-capturing module can capture digital images of the mirrors and the circumstances and objects reflected in the mirrors.
2. By adjusting the angles of the mirrors properly, the mirrors can reflect the views and objects of the regions distributed over a large range, or objects of some specific regions.
3. The capturing range of the image-capturing module needs to include only the mirrors, so the digital image of the mirrors and the views and objects reflected in the mirrors, and captured by the image-capturing module will have high resolution. Thus the digital image can be easily analyzed.

In order to further understand the techniques, means and effects the present invention takes for achieving the prescribed objectives, the following detailed descriptions and appended drawings are hereby referred, such that, and through which, the purposes, features, and aspects of the present invention are able to be thoroughly and concretely appreciated. It is to be understood, however, that the appended drawings are provided solely for reference and illustration, without any intention that they be used for limiting the present invention.

### BRIEF DESCRIPTION OF THE DRAWINGS

FIG. 1 is a perspective view showing a multi-region monitoring system according to the present invention;

FIG. 2 is a side view showing the multi-region monitoring system according to the present invention;

FIG. 3 is a schematic view showing the utilization of the multi-region monitoring system according to the present invention;

FIG. 4 is a schematic view showing a digital image from the multi-region monitoring system according to the present invention;

FIG. 5 is another schematic view showing a digital image from the multi-region monitoring system according to the present invention;

FIG. 6 is a further schematic view showing a digital image from the multi-region monitoring system according to the present invention;

FIG. 7 is another schematic view showing a digital image from the multi-region monitoring system according to the present invention; and

FIG. 8 is a further schematic view showing a digital image from the multi-region monitoring system according to the present invention.

### DETAILED DESCRIPTION OF THE PREFERRED EMBODIMENTS

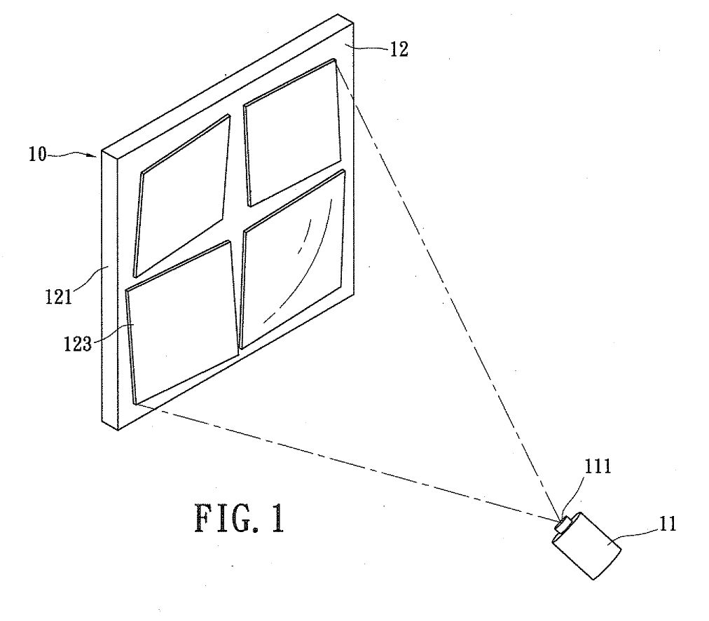

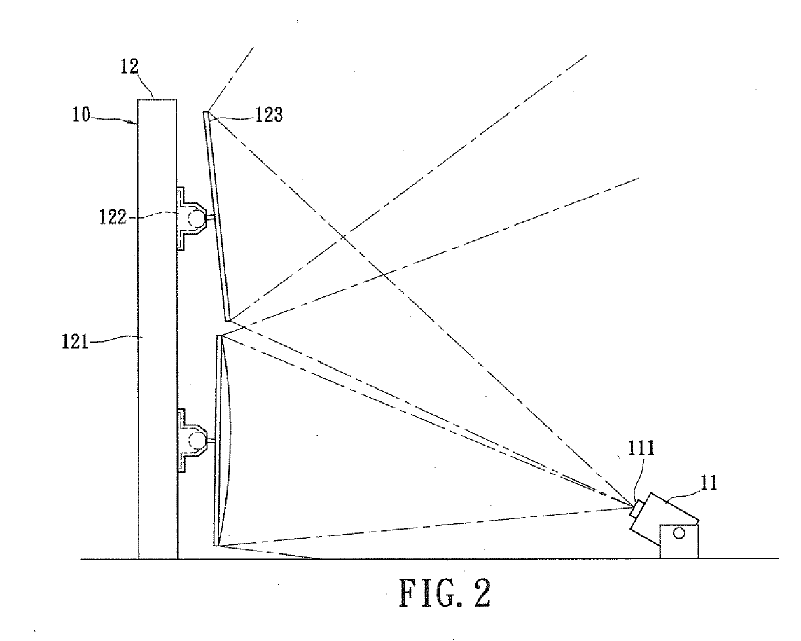

Please refer to FIGS. 1 and 2 in which a multi-region monitoring system according to the present invention is shown, and which comprises: an image-capturing module 11 and a mirror assembly 12.

The image-capturing module 11 is a video camera, a digital camera, or any electronic device able to capture digital images. The image-capturing module 11 has a lens assembly 111 which is provided in one end of the image-capturing module 11. The lens assembly 111 is able to capture a digital image of an object faced, i.e. within the view of the lens assembly 111. The capturing range of the lens assembly 111 only needs to include the mirrors 123, which will be introduced afterward. The digital image can be observed by a display, and can be sent to a processor to be analyzed for identifying, or etc.

The mirror assembly 12 has a base 121, at least two connection seats 122, and at least two mirrors 123. The number of connection seats 122 is the same to that of the mirrors 123. In this embodiment, the number of the mirrors 123 is four, and the mirrors 123 are arranged in a two by two array. The connection seats 122 are provided in a front surface of the base 121, the mirrors 123 are pivotally connected to the connection seats 122 by their rear ends respectively. The mirrors 123 can rotate against the connection seats 122 and face to different directions respectively.

Each front surface of the mirrors 123 is a bright and smooth surface, which causes a specular reflection for incident lights. Therefore, each of the mirrors 123 can clearly reflect an object. Each of the mirrors 123 may be selected from: a plane mirror, a concave mirror, a convex mirror. The concave mirror has an effect of enlarging the object reflected therein, and the convex mirror has a large reflection range. In this embodiment, the mirrors 123 are a combination of three plane mirrors and one convex mirror.

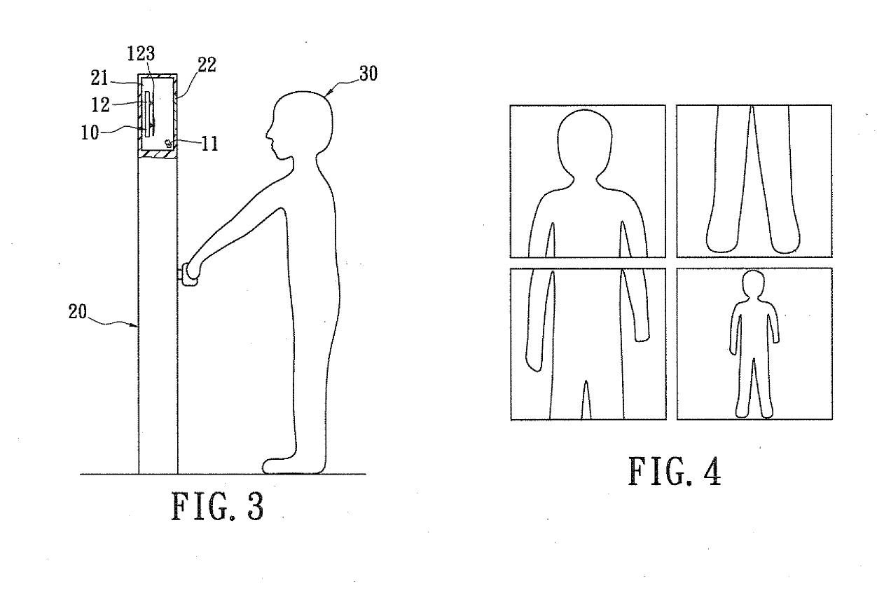

When the image-capturing module 11 and mirror assembly 12 are being assembled, the image-capturing module 11 will be located in front of the mirror assembly 12, and the lens assembly 111 will face the mirrors 123 to ensure the digital image captured by the lens assembly 111 sufficiently includes the mirrors 123 and the objects reflected in the mirrors 123, which means the mirrors 123 and the objects reflected in the mirrors 123 are able to be within the view of the lens assembly 111. Usually, the image-capturing module 11 is not located in straight front of the mirrors (as shown in FIG. 3), which is to prevent from capturing a digital image containing the image-capturing module 11 itself.

When the multi-region monitoring system 10 according to this invention is going to be used, the multi-region monitoring system 10 is first fixed to a specific location, including, as an example corners of a ceiling and wall; then each of the mirrors 123 are adjusted its rotation angle, which makes each of the mirrors 123 face a specific direction and reflect an object of a specific region. Within the process of adjusting rotation angles of the mirrors 123, one can judge whether the objects reflected in the mirrors 123 are intended to be monitored by observing the digital image captured by the image-capturing module 11. If not, the mirrors 123 will be continually adjusted their rotation angles. When the adjustment of rotation angle is finish, the digital image captured by the image-capturing module 11 will contain the objects of intended specific regions.

There are four mirrors 123 in this embodiment, so the image-capturing module 11 will capture a digital image of objects of four different specific regions. If the mirrors 123 are becoming more, the regions to be monitored are accordingly becoming more. Moreover, by properly adjusting the rotation angles of the mirrors 123, the regions to be monitored can be connected together, which forms a large range region to be monitored.

Further, the capturing range of the image-capturing module 11 only needs to include the mirrors, so the captured image will has a higher resolution.

Please refer to FIGS. 3 and 4, the multi-region monitoring system 10 according to this invention may be assembled within a door 20 for identifying whether the visitor 30 is a human being. The door 20 has a receiving space 21 for accommodating the multi-region monitoring system 10, and a transparent area 22 provided on a front side of the door 20 for allowing the mirrors 123 reflecting the objects in front of the door 20.

In this embodiment, the mirrors 123 are four in number, and arranged in a two-by-two array. The rotation angles of the mirrors 123 make the mirrors 123 reflect the objects from the ceiling to the floor in front of the door 20. The object reflected in the lower left mirror 123 overlaps the objects reflected in the upper left and upper right mirrors 123.

When one visitor 30 is standing in front of the door 20, the body features of the visitor 30, i.e. objects, are reflected in the mirrors 123, then the image-capturing module 11 captures a digital image of the mirrors 123.

Please refer to FIG. 4, the captured digital image shows shapes of the four mirrors 123 and the body features reflected in the mirrors 123. Each of the mirrors 123 reflects parts of the body features. For example, the head and body of the visitor 30 are reflected in the upper left mirror 123; the legs of the visitor 30 are reflected in the upper right mirror 123; the body, hands and legs of the visitor 30 are reflected in the lower left mirror 123; the all body features of the visitor 30 are reflected in the lower right mirror 123 because the mirror 123 is a convex mirror.

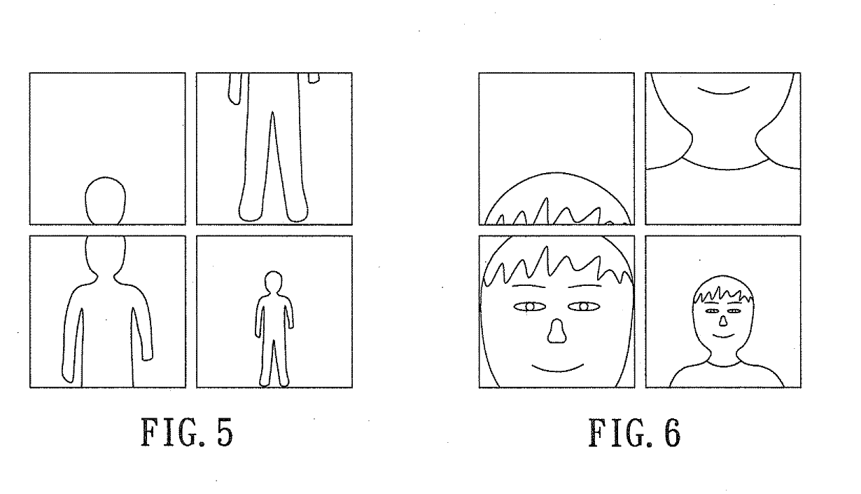

Please refer to FIG. 5, if the visitor 30 is shorter, such as a kid, the mirrors 123 still can reflect all body features of the visitor 30. Further, if the visitor 30 is a cat, dog, or other nonhuman animals (not shown), the upper right and lower right mirrors 123 can reflect those animals.

From above mentioned description, it is known that the objects of the large range region, from ceiling to floor, in front of the door 20 can be monitored and identified by the multi-region monitoring system 10. Therefore, no matter how high the visitor 30 is, the body features of the visitor 30 can be clearly observed from the digital image for determining the visitor 30 is a human being or an animal.

Please refer to FIG. 6 and associated with FIGS. 1 to 3, the multi-region monitoring system 10 of this invention may be applied to identify facial features of the visitor 30 for determining the identification of the visitor 30. When this application is performed, the mirrors 123 can also be four, and arranged in a two by two array

The mirrors 123 reflect the features from hair to chest of the visitor 30. For example, the hair and forehead of the visitor 30 are reflected in the upper left mirror 123; the forehead to the jaw of the visitor 30 are reflected in the lower left mirror 123; the lip to the chest of the visitor 30 are reflected in the upper right mirror 123; and the whole facial features of the visitor 30 are reflected in the lower right mirror 123 because the mirror 123 is a convex mirror. Some facial features are repeatedly reflected in different mirrors 123, such as the eyes of the visitor 30 are repeatedly reflected in lower left and right mirrors for helping identifying the visitor 30. Moreover, no matter how high the visitor 30 is, the facial features of the visitor 30 can be captured.

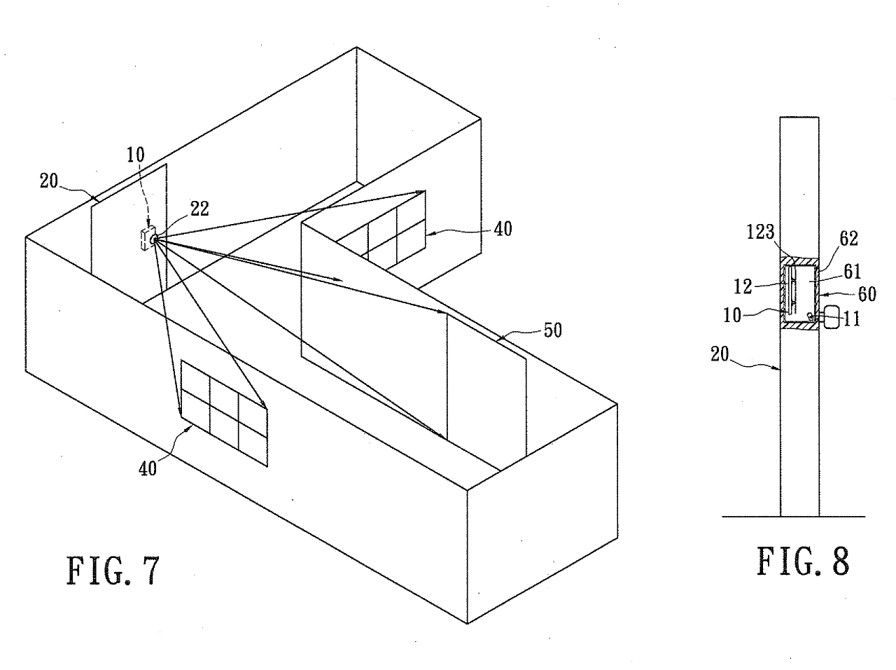

Please refer to FIG. 7, the multi-region monitoring system 10 according to this invention may be applied to monitor several specific regions separated from one another. The multi-region monitoring system 10 is assembled within a door 20, and the mirrors 123 are three in number for this example. One of the mirrors 123 faces the window 40 left to the door 20, another one of the mirrors 123 faces the window 40 right to the door 20, the final mirror 123 of this example faces the exit 50 in front of the door 20. The mirrors 123 reflect the objects of the specific regions, i.e. the windows 40 and the exit 50, the image-capturing module 11 captures the digital image of the objects. Thus, when something abnormal has happened or appears in these regions, such as the window 40 is broken, the user is able to be immediately aware of it from a safe protected location.

Please refer to FIG. 8, the multi-region monitoring system 10 of this invention may be assembled within a lock structure 60. The lock structure 60 has a receiving space 61 for accommodating the multi-region monitoring system 10, and a transparent area 62 for allowing the mirrors 123 reflecting the objects in front of the lock structure 60. Users can assemble the lock structure 60 to a door 20, and perform the functions and applications above mentioned.

Consequently, the multi-region monitoring system 10 according to the present invention has the characteristics as follows:
1. By adjusting the rotation angles of the mirrors 123 properly, the mirrors 123 can reflect the objects of the regions distributed over a large range, or objects of some specific regions.
2. The capturing range of the image-capturing module 11 only needs to include the mirrors 123, not the actual specific regions, so the digital image captured by the image-capturing module 11 has a high resolution.
3. The objects can be repeatedly reflected in the mirrors for helping identifying the objects.
4. The multi-region monitoring system 10 can be applied to identify facial features of human, no matter how tall the human is.
5. The multi-region monitoring system 10 can be applied to identify the visitor 30 as a human being or an animal.
6. The multi-region monitoring system 10 can be assembled within the door 20 or the lock structure 60.

The above-mentioned descriptions represent merely the preferred embodiment of the present invention, without any intention to limit the scope of the present invention. Various equivalent changes, alternations or modifications based on the claims of the present invention are all consequently viewed as being embraced by the scope of the present invention.

What is claimed is:

1. A multi-region monitoring system, comprising:
an image-capturing module having a lens assembly; and
a mirror assembly, having at least two mirrors, the mirror assembly facing the lens assembly;
whereby, each of the mirrors reflects an object, the lens assembly captures a digital image of the objects reflected in the mirrors.

2. The system of claim 1, wherein one of the objects reflected in the mirrors overlaps another one of the objects reflected in the mirrors.

3. The system of claim 1, wherein the mirror assembly has at least two connection seats, the mirrors are pivotally connected to the connection seats respectively.

4. The system of claim 1, wherein one of the mirrors is a plane mirror.

5. The system of claim 1, wherein one of the mirrors is a concave mirror.

6. The system of claim 1, wherein one of the mirrors is a convex mirror.

7. The system of claim 1, wherein the capturing module is a video camera.

8. The system of claim 1, wherein the capturing module is a digital still camera.

9. The system of claim 1, wherein the system is assembled within a door.

10. The system of claim 9, wherein the door has a receiving space and a transparent area, the transparent area is provided on a front side of the door, the system is assembled in the receiving space.

11. The system of claim 1, wherein the system is assembled within a lock structure.

12. The system of claim 11, wherein the lock structure has a receiving space and a transparent area, the transparent area is provided on a front side of the lock structure, the system is assembled in the receiving space.
